(19) United States
(12) Patent Application Publication
(10) Pub. No.: US 2025/0193326 A1
(43) Pub. Date: Jun. 12, 2025

(54) IMAGE READING DEVICE CAPABLE OF READING PLURALITY OF DOCUMENT SHEETS OF DIFFERENT SIZES THAT ARE PLACED ON DOCUMENT SHEET PLACING PORTION, IMAGE FORMING APPARATUS, AND IMAGE READING METHOD

(71) Applicant: KYOCERA Document Solutions Inc., Osaka (JP)

(72) Inventor: Yasuyuki Yabuuchi, Osaka (JP)

(21) Appl. No.: 18/963,010

(22) Filed: Nov. 27, 2024

(30) Foreign Application Priority Data
Dec. 6, 2023 (JP) 2023-205906

(51) Int. Cl. H04N 1/00

(52) U.S. Cl. CPC H04N 1/0071; H04N 1/00748; H04N 1/00774; H04N 1/00615

(57) ABSTRACT

An image reading device includes an image reading portion, a restriction portion, a limitation processing portion, and an output processing portion. The image reading portion reads an image of a document sheet. The restriction portion restricts a position of the document sheet in a width direction. The limitation processing portion limits an image reading range in the width direction to a document sheet width corresponding to a position of the restriction portion. The output processing portion reads, when the image reading range is limited to a specific document sheet width, an image of the document sheet, detects a contact end portion that comes into contact with the restriction portion in the document sheet included in a read image obtained by the reading, and clips and outputs, from the read image, a region determined based on the contact end portion and a determination result on a size of the document sheet.

### INCORPORATION BY REFERENCE

This application is based upon and claims the benefit of priority from the corresponding Japanese Patent Application No. 2023-205906 filed on Dec. 6, 2023, the entire contents of which are incorporated herein by reference.

### BACKGROUND

The present disclosure relates to an image reading device, an image forming apparatus, and an image reading method.

An image reading device which includes an ADF (Auto Document Feeder) that conveys a document sheet is known. This type of image reading device includes a document sheet placing portion, an image reading portion, and a restriction portion. The document sheet conveyed along a predetermined conveying path is placed on the document sheet placing portion. The image reading portion reads an image of the document sheet at a predetermined reading position on the conveying path. The restriction portion is provided in the document sheet placing portion while being movable in a width direction orthogonal to a conveying direction of the document sheet and restricts a position of the document sheet placed on the document sheet placing portion in the width direction.

Further, the image reading device which reads an image of each of a plurality of document sheets that are placed on the document sheet placing portion and whose sizes in the width direction differ is known. For example, this type of image reading device includes a detection processing portion, a limitation processing portion, a determination processing portion, and an output processing portion. The detection processing portion detects a position of the restriction portion in the document sheet placing portion. The limitation processing portion limits an image reading range of the image reading portion in the width direction to a document sheet width corresponding to a detection result obtained by the detection processing portion. The determination processing portion determines a size of the document sheet based on a size of the document sheet in the conveying direction, that is detected from the document sheet conveyed toward the reading position. The output processing portion reads an image of the document sheet that passes through the reading position using the image reading portion, and clips and outputs, from a read image obtained by the reading, a region that is determined based on a specific end portion corresponding to the restriction portion out of both end portions of the read image in the width direction and a determination result obtained by the determination processing portion. The image reading device having the configuration described above is capable of reading, when each of the plurality of document sheets having different sizes in the width direction is placed on the document sheet placing portion so as to come into contact with the restriction portion, an image of each of the plurality of document sheets.

### SUMMARY

An image reading device according to an aspect of the present disclosure includes a document sheet placing portion, an image reading portion, a restriction portion, a detection processing portion, a limitation processing portion, a determination processing portion, and an output processing portion. A document sheet conveyed along a predetermined conveying path is placed on the document sheet placing portion. The image reading portion reads an image of the document sheet at a predetermined reading position on the conveying path. The restriction portion is provided in the document sheet placing portion while being movable in a width direction orthogonal to a conveying direction of the document sheet and restricts a position of the document sheet placed on the document sheet placing portion in the width direction. The detection processing portion detects a position of the restriction portion in the document sheet placing portion. The limitation processing portion limits an image reading range of the image reading portion in the width direction to a document sheet width corresponding to a detection result obtained by the detection processing portion. The determination processing portion determines a size of the document sheet based on a size of the document sheet in the conveying direction, that is detected from the document sheet conveyed toward the reading position. The output processing portion executes, when the image reading range is limited to a predetermined specific document sheet width by the limitation processing portion, output processing for reading an image of the document sheet that passes through the reading position using the image reading portion, detecting a contact end portion that comes into contact with the restriction portion in the document sheet included in a read image obtained by the reading, and clipping and outputting, from the read image, a region that is determined based on the contact end portion and a determination result obtained by the determination processing portion.

An image forming apparatus according to another aspect of the present disclosure includes the image reading device and an image forming portion. The image forming portion forms an image on a sheet based on an image read by the image reading device.

An image reading method according to another aspect of the present disclosure is executed in an image reading device including a document sheet placing portion on which a document sheet conveyed along a predetermined conveying path is placed, an image reading portion which reads an image of the document sheet at a predetermined reading position on the conveying path, and a restriction portion which is provided in the document sheet placing portion while being movable in a width direction orthogonal to a conveying direction of the document sheet and restricts a position of the document sheet placed on the document sheet placing portion in the width direction, and includes a detection step, a limitation step, a determination step, and an output step. The detection step includes detecting a position of the restriction portion in the document sheet placing portion. The limitation step includes limiting an image reading range of the image reading portion in the width direction to a document sheet width corresponding to a detection result obtained by the detection step. The determination step includes determining a size of the document sheet based on a size of the document sheet in the conveying direction, that is detected from the document sheet conveyed toward the reading position. The output step includes executing, when the image reading range is limited to a predetermined specific document sheet width by the limitation step, output processing for reading an image of the document sheet that passes through the reading position using the image reading portion, detecting a contact end portion that comes into contact with the restriction portion in the document sheet included in a read image obtained by the reading, and clipping and outputting, from the read image, a region that is determined based on the contact end portion and a determination result obtained by the determination step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment of the present disclosure;

FIG. 2 is a diagram showing a configuration of an ADF of the image forming apparatus according to the embodiment of the present disclosure;

FIG. 3 is a block diagram showing a system configuration of the image forming apparatus according to the embodiment of the present disclosure;

FIG. 4 is a diagram showing an example of a read image read from a document sheet in the image forming apparatus according to the embodiment of the present disclosure;

FIG. 5 is a diagram showing a read image read from a document sheet of an A4 size in portrait orientation in an image forming apparatus according to a comparative example;

FIG. 6 is a diagram showing a read image read from a document sheet of an A4 size in portrait orientation in the image forming apparatus according to the embodiment of the present disclosure; and

FIG. 7 is a flowchart showing an example of document sheet reading processing executed in the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 100]

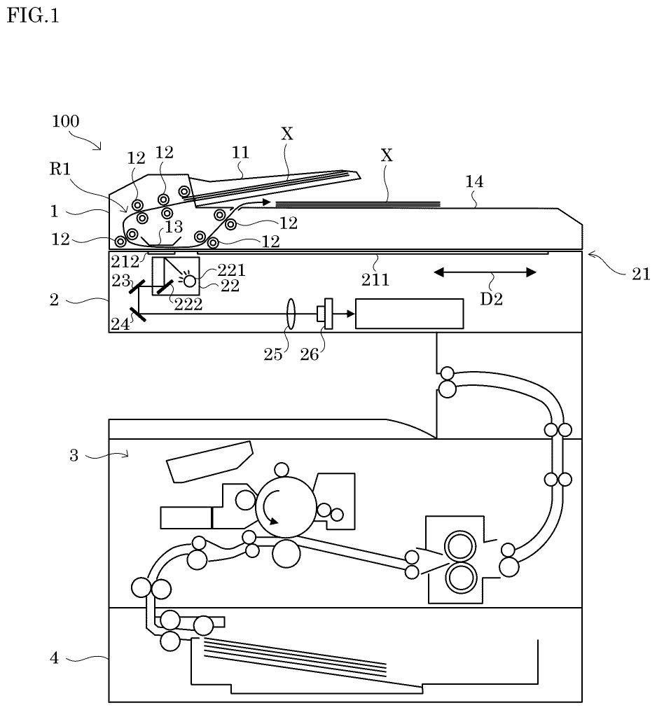

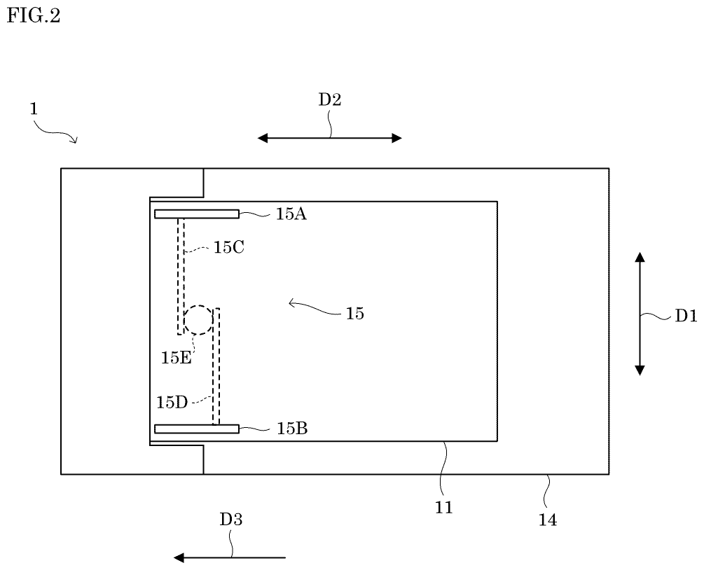

First, a configuration of an image forming apparatus 100 according to the embodiment of the present disclosure will be described with reference to FIG. 1 to FIG. 3. Herein, FIG. 1 is a cross-sectional view showing the configuration of the image forming apparatus 100. Further, FIG. 2 is a plan view showing a configuration of an ADF 1.

The image forming apparatus 100 is a multifunction peripheral having a plurality of functions such as a facsimile function and a copying function together with a scanning function for reading an image from a document sheet X (see FIG. 1) and a printing function for forming an image based on image data. It is noted that the image forming apparatus 100 may alternatively be a copying machine.

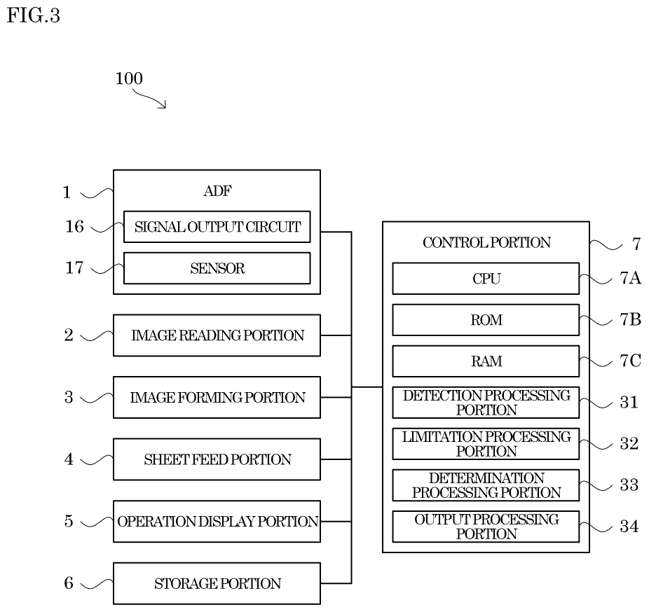

As shown in FIG. 1 and FIG. 3, the image forming apparatus 100 includes an ADF (Auto Document Feeder) 1, an image reading portion 2, an image forming portion 3, a sheet feed portion 4, an operation display portion 5, a storage portion 6, and a control portion 7.

The image forming portion 3 forms an image on a sheet based on image data. Specifically, the image forming portion 3 forms an image on a sheet using electrophotography. For example, the image forming portion 3 includes a photoconductor drum, a charging roller, a laser scanning unit, a developing device, a transfer roller, a cleaning device, a fixing device, and a sheet discharge tray. It is noted that the image forming portion 3 may form an image on a sheet using other image forming systems such as an inkjet system.

The sheet feed portion 4 supplies sheets to the image forming portion 3. The sheet feed portion 4 includes a sheet feed cassette and a plurality of conveying rollers.

The operation display portion 5 is a user interface of the image forming apparatus 100. The operation display portion 5 includes a display portion and an operation portion. The display portion displays various types of information in response to control instructions from the control portion 7. For example, the display portion is a liquid crystal display. The operation portion is used to input various types of information to the control portion 7 according to user operations. For example, the operation portion is a touch panel.

The storage portion 6 is a nonvolatile storage device. For example, the storage portion 6 is a nonvolatile memory such as a flash memory. It is noted that the storage portion 6 may alternatively be an SSD (Solid State Drive) or an HDD (Hard Disk Drive).

The control portion 7 collectively controls the image forming apparatus 100. As shown in FIG. 3, the control portion 7 includes a CPU 7A, a ROM 7B, and a RAM 7C. The CPU 7A is a processor which executes various types of calculation processing. The ROM 7B is a nonvolatile storage device in which information such as control programs for causing the CPU 7A to execute various types of processing is stored in advance. The RAM 7C is a volatile or nonvolatile storage device that is used as a temporary storage memory (working area) for the various types of processing to be executed by the CPU 7A. In the control portion 7, the CPU 7A executes the various control programs stored in advance in the ROM 7B. Thus, the control portion 7 collectively controls the image forming apparatus 100. It is noted that the control portion 7 may alternatively be configured by an electronic circuit such as an integrated circuit (ASIC). Alternatively, the control portion 7 may be a control portion provided separate from a main control portion which collectively controls the image forming apparatus 100.

The ADF 1 conveys the document sheet X from which an image is to be read by the image reading portion 2. As shown in FIG. 1, the ADF 1 includes a document sheet tray 11, a plurality of conveying rollers 12, a document sheet guide 13, and a sheet discharge portion 14.

The document sheet X conveyed along a predetermined conveying path R1 (see FIG. 1) is placed on the document sheet tray 11. The conveying path R1 is a path that is provided from the document sheet tray 11 to the sheet discharge portion 14 via an inside of a housing of the ADF 1. The plurality of conveying rollers 12 are arranged along the conveying path R1. Each of the conveying rollers 12 is driven by a driving force supplied from a motor (not shown). Thus, the document sheet X placed on the document sheet tray 11 is conveyed along the conveying path R1. The document sheet guide 13 is provided on the conveying path R1 and guides the document sheet X conveyed along the conveying path R1 to an image reading position of the image reading portion 2. The reading position is an upper surface of second contact glass 212 of a document sheet table 21 (see FIG. 1). The document sheet X from which the image has been read is discharged to the sheet discharge portion 14. The document sheet tray 11 is an example of a document sheet placing portion according to the present disclosure.

The image reading portion 2 reads an image of the document sheet X at the reading position. In addition, the image reading portion 2 reads an image of the document sheet X placed on first contact glass 211 of the document sheet table 21 (see FIG. 1). Specifically, the image reading portion 2 reads an image of the document sheet X using a CCD (Charge Coupled Device) system. As shown in FIG. 1, the image reading portion 2 includes the document sheet table 21, a reading unit 22, a mirror 23, a mirror 24, an optical lens 25, and a CCD 26.

The document sheet table 21 is an upper surface portion of a box-like housing which houses the respective constituent elements of the image reading portion 2. As shown in FIG. 1, the document sheet table 21 includes the first contact glass 211 and the second contact glass 212. The document sheet X is placed on an upper surface of the first contact glass 211. Light emitted from the reading unit 22 toward the document sheet X conveyed by the ADF 1 passes through the second contact glass 212.

As shown in FIG. 1, the ADF 1 is provided on an upper side of the document sheet table 21. The ADF 1 is provided while being capable of changing its attitude between a closed attitude in which it covers the first contact glass 211 and an opened attitude in which it exposes the first contact glass 211. Thus, the ADF 1 functions as a document sheet cover with respect to the document sheet X placed on the first contact glass 211.

As shown in FIG. 1, the reading unit 22 is provided below the first contact glass 211 and the second contact glass 212. The reading unit 22 is configured to be movable in a sub-scanning direction D2 shown in FIG. 2 by a movement mechanism (not shown) that includes a drive portion such as a stepping motor. As shown in FIG. 1, the reading unit 22 includes a light source 221 and a mirror 222.

The light source 221 is a plurality of LEDs arrayed along a main-scanning direction D1 (see FIG. 2). The main-scanning direction D1 is a direction orthogonal to the sub-scanning direction D2. The light source 221 irradiates light corresponding to one line in the main-scanning direction D1 toward the first contact glass 211 or the second contact glass 212. The light emitted from the light source 221 passes through the first contact glass 211 or the second contact glass 212 to be irradiated onto the document sheet X placed on the first contact glass 211 or the document sheet X conveyed by the ADF 1. The mirror 222 reflects the light that has been emitted from the light source 221 and reflected by the document sheet X toward the mirror 23.

In the image reading portion 2, when an image is read from the document sheet X placed on the first contact glass 211, the reading unit 22 is moved in the sub-scanning direction D2 by the movement mechanism. Thus, the light irradiated onto the document sheet X from the light source 221 is scanned in the sub-scanning direction D2. In addition, in the image reading portion 2, when an image is read from the document sheet X conveyed by the ADF 1, the reading unit 22 is moved to a position below the second contact glass 212 by the movement mechanism. Thus, the light emitted from the light source 221 passes through the second contact glass 212 to be irradiated onto the document sheet X conveyed by the ADF 1.

The mirror 23 reflects the light reflected by the mirror 222 of the reading unit 22 toward the mirror 24. The mirror 24 reflects the light reflected by the mirror 23 toward the optical lens 25. The optical lens 25 collects the light reflected by the mirror 24 and causes the light to enter the CCD 26.

The CCD 26 is an image sensor that includes a plurality of photoelectric conversion elements arrayed along the main-scanning direction D1. The CCD 26 outputs electric signals corresponding to a light amount of received light. In the image reading portion 2, the light that has been emitted from the light source 221 and reflected by the document sheet X enters the CCD 26 via the mirror 222, the mirror 23, the mirror 24, and the optical lens 25. Thus, analog electric signals corresponding to the image of the document sheet X are output from the CCD 26. The analog electric signals output from the CCD 26 are converted into digital electric signals (image data) by an AFE (Analog Front End) circuit (not shown), and the digital electric signals are input to the control portion 7. The image data output from the image reading portion 2 is used for forming an image by the image forming portion 3.

As shown in FIG. 2 and FIG. 3, the ADF 1 includes a document sheet restriction portion 15, a signal output circuit 16, and a sensor 17.

The document sheet restriction portion 15 restricts a position of the document sheet X placed on the document sheet tray 11 in a width direction. The width direction is a direction orthogonal to a conveying direction D3 (see FIG. 2) of the document sheet X by the ADF 1 and is the same as the main-scanning direction D1. As shown in FIG. 2, the document sheet restriction portion 15 includes a first guide member 15A, a second guide member 15B, a first rack 15C, a second rack 15D, and a pinion 15E.

The first guide member 15A is provided in the document sheet tray 11 while being movable in the width direction and restricts the position of the document sheet X placed on the document sheet tray 11 in the width direction. The first guide member 15A is a flat plate-like member that is elongated in the conveying direction D3 and has a thickness in the width direction.

The second guide member 15B is provided in the document sheet tray 11 while being movable in the width direction and restricts the position of the document sheet X placed on the document sheet tray 11 in the width direction. Similar to the first guide member 15A, the second guide member 15B is a flat plate-like member that is elongated in the conveying direction D3 and has a thickness in the width direction. The second guide member 15B is provided opposed to the first guide member 15A in the width direction.

The first rack 15C is provided while being movable integrally with the first guide member 15A. The first rack 15C is provided below the upper surface of the document sheet tray 11. The first rack 15C is elongated in the width direction, and teeth are formed on a side surface thereof on an upstream side of the conveying direction D3.

The second rack 15D is provided while being movable integrally with the second guide member 15B. The second rack 15D is provided below the upper surface of the document sheet tray 11. The second rack 15D is elongated in the width direction, and teeth are formed on a side surface thereof on a downstream side of the conveying direction D3.

The pinion 15E is provided to intermesh with both of the first rack 15C and the second rack 15D at a position between the first rack 15C and the second rack 15D. Below the upper surface of the document sheet tray 11, the pinion 15E is supported while being rotatable about a shaft orthogonal to the upper surface.

In the document sheet restriction portion 15, the first guide member 15A and the second guide member 15B move in an interlocking manner in a direction in which they approach each other or a direction in which they move away from each other in the width direction by the first rack 150, the second rack 15D, and the pinion 15E. Thus, the document sheet restriction portion 15 can position the document sheet X placed on the document sheet tray 11 at a center of the document sheet tray 11 in the width direction. It is noted that in the document sheet tray 11, only the first guide member 15A out of the first guide member 15A and the second guide member 15B may be provided to be movable, and the other one of the two may be provided to be unmovable. The first guide member 15A is an example of a restriction portion according to the present disclosure.

The signal output circuit 16 outputs an electric signal corresponding to a position of the first guide member 15A in the document sheet tray 11. In other words, the signal output circuit 16 outputs an electric signal corresponding to a parting distance between the first guide member 15A and the second guide member 15B in the width direction. For example, the signal output circuit 16 is an electronic circuit that includes a variable resistor whose electric resistance value varies according to a rotation of the pinion 15E. The signal output circuit 16 outputs an electric signal corresponding to the electric resistance value of the variable resistor. The electric signal output from the signal output circuit 16 is input to the control portion 7.

The sensor 17 is used for detecting a size of the document sheet X conveyed toward the reading position, in the conveying direction D3. For example, the sensor 17 is a reflective or transmissive photosensor that is capable of detecting the document sheet X at a position more on the upstream side of the conveying direction D3 than the reading position on the conveying path R1.

When a plurality of document sheets X having different document sheet widths are placed on the document sheet tray 11 such that each of the plurality of document sheets X comes into contact with the first guide member 15A, the image forming apparatus 100 is capable of reading an image of each of the plurality of document sheets X.

### [Configuration of Control Portion 7]

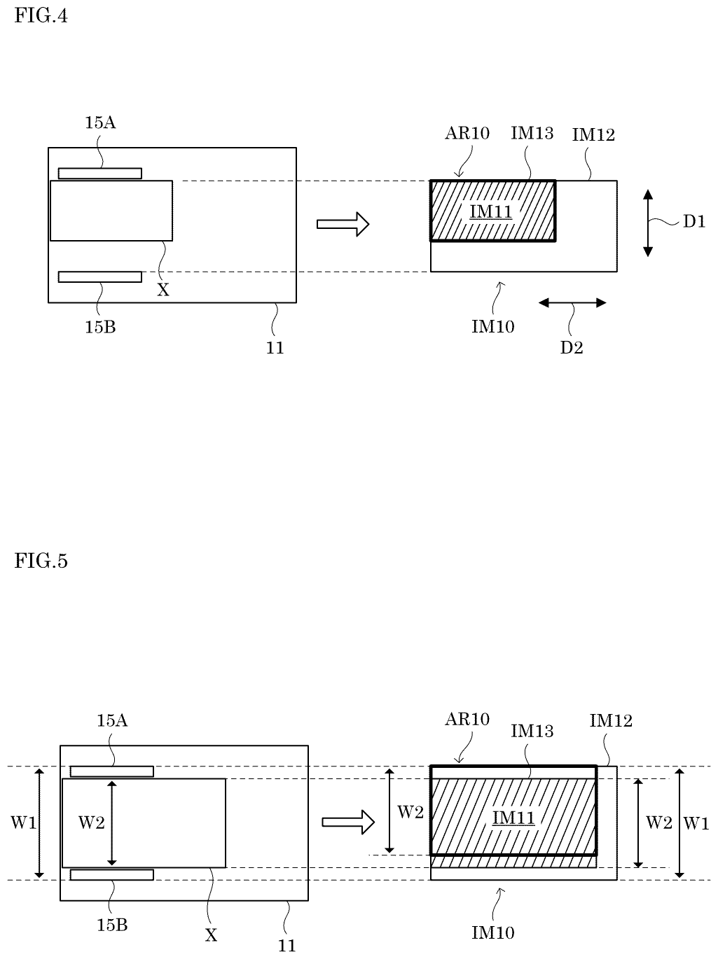

Next, a configuration of the control portion 7 will be described with reference to FIG. 3 and FIG. 4. It is noted that in FIG. 4, a document sheet region IM11 included in a read image IM10 is hatched. Also in FIG. 4, a first region AR10 clipped from the read image IM10 is indicated by a bold line.

As shown in FIG. 3, the control portion 7 includes a detection processing portion 31, a limitation processing portion 32, a determination processing portion 33, and an output processing portion 34. A device including the ADF 1, the image reading portion 2, and the control portion 7 is an example of an image reading device according to the present disclosure.

Specifically, a document sheet reading program for causing the CPU 7A of the control portion 7 to function as the respective processing portions described above is stored in advance in the ROM 7B of the control portion 7. Then, the CPU 7A of the control portion 7 executes the document sheet reading program stored in the ROM 7B to thus function as the respective processing portions described above. It is noted that some or all of the processing portions included in the control portion 7 may be configured by an electronic circuit. Alternatively, the document sheet reading program may be a program for causing a plurality of processors to function as the respective processing portions included in the control portion 7.

The detection processing portion 31 detects the position of the first guide member 15A in the document sheet tray 11.

Specifically, the detection processing portion 31 uses the signal output circuit 16 to detect the position of the first guide member 15A in the document sheet tray 11. For example, the detection processing portion 31 acquires the parting distance between the first guide member 15A and the second guide member 15B based on the electric signal output from the signal output circuit 16. Alternatively, the detection processing portion 31 may acquire positional information that indicates the position of the first guide member 15A in the document sheet tray 11 based on the electric signal output from the signal output circuit 16.

The limitation processing portion 32 limits an image reading range of the image reading portion 2 in the main-scanning direction D1 (the width direction) to a document sheet width corresponding to the detection result obtained by the detection processing portion 31.

For example, the limitation processing portion 32 acquires the document sheet width corresponding to the detection result obtained by the detection processing portion 31 using table data that indicates a correspondence relationship between the parting distance between the first guide member 15A and the second guide member 15B, that is acquired by the detection processing portion 31, and a document sheet width of the document sheet X of a standard size. It is noted that the table data only needs to be stored in advance in the ROM 7B or the storage portion 6.

For example, the limitation processing portion 32 limits the image reading range by limiting drive of each of a pair of regions extending from both end portions of the light source 221 in the main-scanning direction D1 toward a center portion and a pair of regions extending from both end portions of the CCD 26 in the main-scanning direction D1 toward a center portion.

The determination processing portion 33 determines a size of the document sheet X based on a size of the document sheet X in the conveying direction D3, that is detected from the document sheet X conveyed toward the reading position.

Specifically, the determination processing portion 33 uses the sensor 17 to detect the size of the document sheet X conveyed toward the reading position, in the conveying direction D3. In addition, the determination processing portion 33 specifies the size of the document sheet X based on the size of the document sheet X in the conveying direction D3 and the detection result obtained by the detection processing portion 31.

The output processing portion 34 executes first output processing for reading an image of the document sheet X that passes through the reading position using the image reading portion 2, and clipping and outputting, from the read image IM10 (see FIG. 4) obtained by the reading, the first region AR10 (see FIG. 4) that is determined based on a specific end portion IM12 (see FIG. 4) corresponding to the first guide member 15A out of both end portions of the read image IM10 in the main-scanning direction D1 (the width direction) and the determination result obtained by the determination processing portion 33. The first region AR10 is a region that is determined using the specific end portion IM12 in the read image IM10 as a reference and is a region having a size that is the same as the size of the document sheet X determined by the determination processing portion 33. The read image IM10 is an image in which the size thereof in the main-scanning direction D1 is the same as the document sheet width corresponding to the detection result obtained by the detection processing portion 31 and in which the size thereof in the sub-scanning direction D2 is a predetermined size.

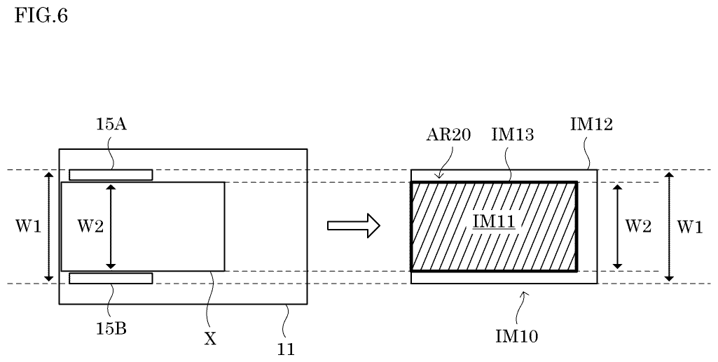

Meanwhile, in the image forming apparatus 100, when the size of the document sheet X placed on the document sheet tray 11 is an A4 size in portrait orientation or a letter size, since a size difference between the document sheet widths of both sizes is too small, it is impossible to distinguish which of a document sheet width W2 of the A4 size in portrait orientation (see FIG. 5) or a document sheet width W1 of the letter size (see FIG. 5) the document sheet width of the document sheet X is. In contrast, there is a configuration for limiting, irrespective of whether the size of the document sheet X placed on the document sheet tray 11 is either the A4 size in portrait orientation or the letter size, the image reading range of the image reading portion 2 to the document sheet width W1 of the letter size. With this configuration, when the size of the document sheet X placed on the document sheet tray 11 is the letter size, the entire image of the document sheet X can be read. With this configuration, however, as shown in FIG. 5, when the size of the document sheet X placed on the document sheet tray 11 is the A4 size in portrait orientation, the document sheet region IM11 in the read image IM10 is deviated from the specific end portion IM12 toward a center of the read image IM10 in the main-scanning direction D1 (the width direction), so not all of the image of the document sheet X in the A4 size in portrait orientation can be read.

In contrast, in the image forming apparatus 100 according to the embodiment of the present disclosure, it is possible to suppress an image reading failure of each of the plurality of document sheets X that are placed on the document sheet tray 11 and whose sizes in the width direction differ as will be described below.

Specifically, in the image forming apparatus 100, when the parting distance between the first guide member 15A and the second guide member 15B, that is acquired by the detection processing portion 31, is included in a specific range that includes both of the document sheet width W2 of the A4 size in portrait orientation (see FIG. 5) and the document sheet width W1 of the letter size (see FIG. 5), the image reading range of the image reading portion 2 is limited to the document sheet width W1 of the letter size.

Further, the output processing portion 34 executes the first output processing when the image reading range is not limited to the document sheet width W1 of the letter size (an example of a specific document sheet width according to the present disclosure) by the limitation processing portion 32.

Furthermore, when the image reading range is limited to the document sheet width W1 of the letter size by the limitation processing portion 32, the output processing portion 34 executes second output processing for reading an image of the document sheet X that passes through the reading position using the image reading portion 2, detecting a contact end portion IM13 (see FIG. 6) that comes into contact with the first guide member 15A in the document sheet X (the document sheet region IM11) included in the read image IM10 obtained by the reading (see FIG. 6), and clipping and outputting, from the read image IM10, a second region AR20 (see FIG. 6) that is determined based on the contact end portion IM13 and the determination result obtained by the determination processing portion 33. The second region AR20 is a region determined using the contact end portion IM13 in the read image IM10 as a reference and is a region having a size that is the same as the size of the document sheet X determined by the determination processing portion 33.

It is noted that when the image reading range is limited to the document sheet width W1 of the letter size by the limitation processing portion 32, the output processing portion 34 may execute the second output processing when the determination result obtained by the determination processing portion 33 differs from the letter size (an example of a specific size according to the present disclosure) and execute the first output processing when the determination result obtained by the determination processing portion 33 is the letter size.

### [Document Sheet Reading Processing]

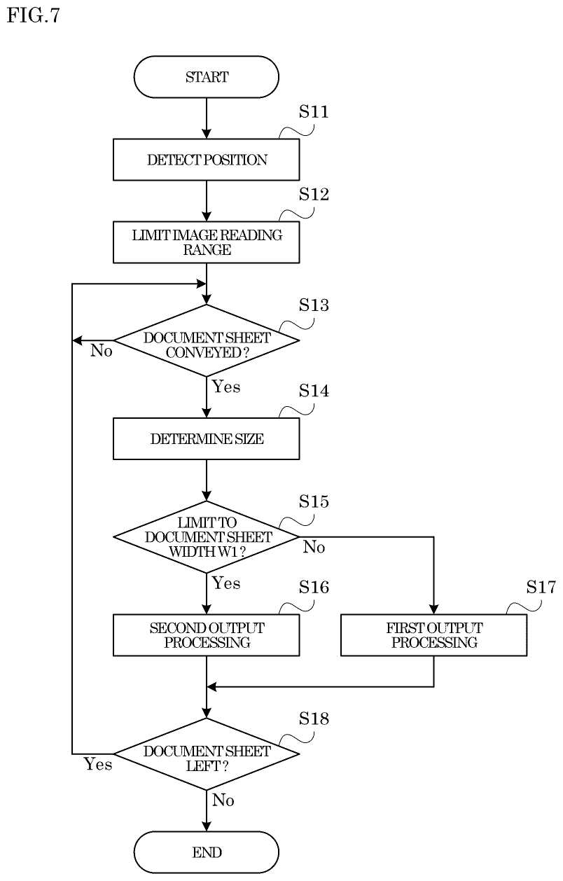

Hereinafter, with reference to FIG. 7, an image reading method according to the present disclosure will be described along with exemplary procedures of the document sheet reading processing executed by the control portion 7 in the image forming apparatus 100. Herein, Step S11, Step S12, . . . represent numbers of processing procedures (steps) executed by the control portion 7. It is noted that the document sheet reading processing is executed when an instruction to execute image reading processing for reading an image of a document sheet placed on the document sheet tray 11 is input.

### <Step S11>

First, in Step S11, the control portion 7 detects the position of the first guide member 15A in the document sheet tray 11. Herein, the processing of Step S11 is an example of a detection step according to the present disclosure and is executed by the detection processing portion 31 of the control portion 7.

### <Step S12>

In Step S12, the control portion 7 limits the image reading range of the image reading portion 2 to the document sheet width corresponding to the detection result obtained by the processing of Step S11. Herein, the processing of Step S12 is an example of a limitation step according to the present disclosure and is executed by the limitation processing portion 32 of the control portion 7.

### <Step S13>

In Step S13, the control portion 7 determines whether or not the document sheet X has been conveyed from the document sheet tray 11 by the ADF 1.

Herein, when determining that the document sheet X has been conveyed from the document sheet tray 11 by the ADF 1 (Yes in S13), the control portion 7 shifts the processing to Step S14. On the other hand, when determining that the document sheet X has not been conveyed from the document sheet tray 11 by the ADF 1 (No in S13), the control portion 7 waits for the conveyance of the document sheet X from the document sheet tray 11 in Step S13.

### <Step S14>

In Step S14, the control portion 7 determines the size of the document sheet X based on the size of the document sheet X in the conveying direction D3, that is detected from the document sheet X conveyed toward the reading position. Herein, the processing of Step S14 is an example of a determination step according to the present disclosure and is executed by the determination processing portion 33 of the control portion 7.

### <Step S15>

In Step S15, the control portion 7 determines whether or not the image reading range has been limited to the document sheet width W1 of the letter size by the processing of Step S12.

Herein, when determining that the image reading range has been limited to the document sheet width W1 of the letter size by the processing of Step S12 (Yes in S15), the control portion 7 shifts the processing to Step S16. On the other hand, when determining that the image reading range has not been limited to the document sheet width W1 of the letter size (No in S15), the control portion 7 shifts the processing to Step S17.

### <Step S16>

In Step S16, the control portion 7 executes the second output processing. Herein, the processing of Step S16 is an example of an output step according to the present disclosure and is executed by the output processing portion 34 of the control portion 7.

### <Step S17>

In Step S17, the control portion 7 executes the first output processing. Herein, the processing of Step S17 is executed by the output processing portion 34 of the control portion 7.

### <Step S18>

In Step S18, the control portion 7 determines whether or not the document sheet X is remaining on the document sheet tray 11. It is noted that the control portion 7 is capable of determining whether or not the document sheet X is remaining on the document sheet tray 11 using a document sheet sensor (not shown) that is capable of detecting the presence or absence of the document sheet X on the document sheet tray 11.

Herein, when determining that the document sheet X is remaining on the document sheet tray 11 (Yes in S18), the control portion 7 shifts the processing to Step S13. On the other hand, when determining that the document sheet X is not remaining on the document sheet tray 11 (No in S18), the control portion 7 ends the document sheet reading processing.

In this manner, in the image forming apparatus 100, the second output processing is executed when the image reading range is limited to the document sheet width W1 of the letter size by the limitation processing portion 32. Thus, an image clipping region from the read image IM10 is determined using the contact end portion IM13 as a reference instead of the specific end portion IM12 (see FIG. 6). Therefore, when the size of the document sheet X placed on the document sheet tray 11 is the A4 size in portrait orientation, the entire image of the document sheet X can be read. Accordingly, it is possible to suppress an image reading failure of each of the plurality of document sheets X that are placed on the document sheet tray 11 and whose sizes in the width direction differ as in the case of the document sheet X in the A4 size in portrait orientation and the document sheet X in a B5 size in portrait orientation, for example.

It is noted that the image reading portion according to the present disclosure is not limited to the image reading portion 2 and may alternatively be a CIS (Contact Image Sensor) provided inside the ADF 1.

Moreover, the specific document sheet width according to the present disclosure is not limited to the document sheet width W1 of the letter size.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading device, comprising:
a document sheet placing portion on which a document sheet conveyed along a predetermined conveying path is placed;
an image reading portion which reads an image of the document sheet at a predetermined reading position on the conveying path;
a restriction portion which is provided in the document sheet placing portion while being movable in a width direction orthogonal to a conveying direction of the document sheet and restricts a position of the document sheet placed on the document sheet placing portion in the width direction;
a detection processing portion which detects a position of the restriction portion in the document sheet placing portion;
a limitation processing portion which limits an image reading range of the image reading portion in the width direction to a document sheet width corresponding to a detection result obtained by the detection processing portion;
a determination processing portion which determines a size of the document sheet based on a size of the document sheet in the conveying direction, that is detected from the document sheet conveyed toward the reading position; and
an output processing portion which executes, when the image reading range is limited to a predetermined specific document sheet width by the limitation processing portion, output processing for reading an image of the document sheet that passes through the reading position using the image reading portion, detecting a contact end portion that comes into contact with the restriction portion in the document sheet included in a read image obtained by the reading, and clipping and outputting, from the read image, a region that is determined based on the contact end portion and a determination result obtained by the determination processing portion.

2. The image reading device according to claim 1, wherein
the output processing portion executes the output processing when the image reading range is limited to the specific document sheet width by the limitation processing portion and the determination result obtained by the determination processing portion differs from a specific size corresponding to the specific document sheet width.

3. An image forming apparatus, comprising:
the image reading device according to claim 1; and
an image forming portion which forms an image on a sheet based on an image read by the image reading device.

4. An image reading method executed in an image reading device including a document sheet placing portion on which a document sheet conveyed along a predetermined conveying path is placed, an image reading portion which reads an image of the document sheet at a predetermined reading position on the conveying path, and a restriction portion which is provided in the document sheet placing portion while being movable in a width direction orthogonal to a conveying direction of the document sheet and restricts a position of the document sheet placed on the document sheet placing portion in the width direction, the image reading method comprising:
a detection step of detecting a position of the restriction portion in the document sheet placing portion;
a limitation step of limiting an image reading range of the image reading portion in the width direction to a document sheet width corresponding to a detection result obtained by the detection step;
a determination step of determining a size of the document sheet based on a size of the document sheet in the conveying direction, that is detected from the document sheet conveyed toward the reading position; and
an output step of executing, when the image reading range is limited to a predetermined specific document sheet width by the limitation step, output processing for reading an image of the document sheet that passes through the reading position using the image reading portion, detecting a contact end portion that comes into contact with the restriction portion in the document sheet included in a read image obtained by the reading, and clipping and outputting, from the read image, a region that is determined based on the contact end portion and a determination result obtained by the determination step.
